(19) United States
(12) Patent Application Publication
(10) Pub. No.: US 2025/0030521 A1
(43) Pub. Date: Jan. 23, 2025

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/909,973

(22) Filed: Oct. 9, 2024

Related U.S. Application Data
(63) Continuation of application No. PCT/CN2023/086461, filed on Apr. 6, 2023.

(30) Foreign Application Priority Data
Apr. 14, 2022 (CN) 202210390652.5

(51) Int. Cl. H04L 5/00

(52) U.S. Cl. CPC H04L 5/0053

(57) ABSTRACT

A node first receives a first information block, the first information block is used to indicate K1 reference signal resource groups, and any of the K1 reference signal resource groups comprises at least one reference signal resource; then measures a first reference signal resource group, the first reference signal resource group is one of the K1 reference signal resource groups; and transmits a first measurement result, a measurement for the first reference signal resource group is used to obtain the first measurement result; the reference signal resource comprises at least one of an SSB or CSI-RS resources; location information of the first node is used to determine the first reference signal resource group from the K1 reference signal resource groups. The present application improves the configuration and reporting method of measurements under a 5G NR system with the introduction of UAVs to reduce the measurement overhead.

### CROSS REFERENCE TO RELATED APPLICATIONS

The present application is the continuation of the international patent application No. PCT/CN2023/086461, filed on Apr. 6, 2023, and claims the priority benefit of Chinese Patent Application CN202210390652.5, filed on Apr. 14, 2022, the full disclosure of which is incorporated herein by reference.

### BACKGROUND

### Technical Field

The present application relates to transmission methods and devices in wireless communication systems, and in particular to a design scheme and a device for measurement in wireless communications.

### Related Art

In the discussion of Rel-18 topics in 5G NR, UAVs (Uncrewed Aerial Vehicles) based services are included in the discussion of new R-18 topics. As early as during LTE (Long-term Evolution), UAVs have been discussed and studied in 3GPP, and accordingly new Events based on UAVs proposed for triggering measurement reports were introduced into the high-layer protocol. Compared to the LTE era, NR empowers UAVs with more diverse applications, as well as low-latency control and high-data-rate multi-media services.

Considering the introduction of Massive MIMO (multi-Input Multi-Output) in NR. More complex beamforming scenarios, and the resulting narrower beams, will pose additional challenges in wireless scenarios where UAVs are introduced. One of the important issues is the problem of intra-cell and inter-cell interference, and the corresponding solutions need to be considered.

### SUMMARY

Compared with the traditional UE, the location of UAV can reach an altitude of 300 meters, the mobile range of UAV itself is larger compared with the traditional terminal, and the mobile speed is faster compared with the traditional terminal; in turn, the UAV terminal is able to receive signals from more cells and at the same time the signals it transmits can reach more cells. Therefore, the UAV terminal, compared to an ordinary terrestrial terminal, needs to consider more refined mechanisms for interference measurement and reporting to reduce intra-cell and inter-cell interference. However, in NR systems, due to the introduction of beamforming, measurements become more complex, requiring more reference signals to be measured and corresponding resources.

To address the above problem, the present application provides a solution. It should be noted that although the above description is based on the scenario where UAV terminals are introduced, and massive MIMO and beam-based communication scenarios are used as examples, the present application is also applicable to other scenarios such as terrestrial terminal scenarios, where similar technical effects can be achieved. Additionally, the adoption of a unified solution for various scenarios (including but not limited to massive MIMO, beam-based communications and LTE multi-antenna systems) contributes to the reduction of hardware complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

Further, the embodiments of a first node in the present application and the characteristics of the embodiments may be applied to a second node if no conflict is incurred, and vice versa. Particularly, for interpretations of the terminology, nouns, functions and variants (if not specified) in the present application, refer to definitions given in Technical Specification (TS) 36 series, TS38 series and TS37 series of 3GPP specifications.

The present application provides a method in a first node for wireless communications, comprising:
receiving a first information block, the first information block being used to indicate K1 reference signal resource groups, K1 being a positive integer greater than 1, any of the K1 reference signal resource groups comprising at least one reference signal resource; measuring a first reference signal resource group, the first reference signal resource group being one of the K1 reference signal resource groups; and
transmitting a first measurement result, a measurement for the first reference signal resource group being used to obtain the first measurement result;
herein, the reference signal resource comprises at least one of an SSB (Synchronization Signal/physical broadcast channel Block) or CSI-RS (Channel State Information Reference Signal) resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, one technical feature of the above method is in: establishing a connection between location information of UAV and a reference signal resource group that actually needs to be detected, avoiding the UAV terminal needing from detecting all reference signal resources in all cells at any time and reducing the complexity of the UAV terminal.

In one embodiment, another technical feature of the above method is in: when the altitude of the UAV is high, or the coverage of the WayPointLocation is small, the number of reference signal resources to be monitored by the UAV may be reduced, for example by monitoring only the first reference signal resource group in the K1 reference signal resource groups, thereby reducing the complexity and improving the measurement efficiency.

According to one aspect of the present application, the first measurement result comprises L1 reference signal index (indices), L1 being a positive integer not greater than a first threshold, and the first threshold is related to the location information of the first node.

In one embodiment, one technical feature of the above method is in: furthermore, location information is also used to determine a number of reference signal resources reported in a measurement report, further reducing complexity.

According to one aspect of the present application, the first measurement result comprises M1 serving cells, M1 being a positive integer not greater than a second threshold, and the second threshold is related to the location information of the first node.

In one embodiment, one technical feature of the above method is in: furthermore, location information is also used to determine a number of cell(s) reported in a measurement report, further reducing complexity.

According to one aspect of the present application, as a response to an occurrence of a first event, the behavior of occurring a first measurement result is triggered; the first event is any candidate event in a first candidate event set; the first measurement result comprises L1 reference signal index (indices), L1 being a positive integer not greater than a first threshold; the first candidate event set is used to determine the first threshold.

In one embodiment, one technical feature of the above method is in: furthermore, the first event set defined for the UAV terminal is used to determine a maximum number of reference signal resources for measurement reporting.

According to one aspect of the present application, as a response to an occurrence of a first event, the behavior of occurring a first measurement result is triggered; the first event is any candidate event in a first candidate event set; the first measurement result comprises M1 serving cell(s), M1 being a positive integer not greater than a second threshold; the first candidate event set is used to determine the second threshold.

In one embodiment, one technical feature of the above method is in: furthermore, the first event set defined for the UAV terminal is used to determine a maximum number of serving cell(s) for measurement reporting.

According to one aspect of the present application, comprising:
transmitting a target information block;
herein, the target information block comprises subscription information of the first node, and K1 is related to the subscription information of the first node.

In one embodiment, one technical feature of the above method is in: the subscription information of the first node is used to report that the first node is a UAV terminal.

According to one aspect of the present application, K1 is a positive integer greater than 1, the K1 reference signal resource groups also comprise a second reference signal resource group, and both the first reference signal resource group and the second reference signal resource group comprise a first reference signal resource.

In one embodiment, one technical feature of the above method is in: the K1 reference signal resource groups are applied to different scenarios, and reference signal resources carried by themselves are partially overlapping.

According to one aspect of the present application, as a response to an occurrence of a first event, the behavior of occurring a first measurement result is triggered; the first event is any candidate event in a first candidate event set.

According to one aspect of the present application, any of the K1 reference signal resource groups is associated with multiple PCIs.

According to one aspect of the present application, any of the K1 reference signal resource groups is associated with a first PCI set, and the first PCI set at least comprises two different PCIs.

According to one aspect of the present application, the K1 reference signal resource groups are associated with a same MeasObject.

According to one aspect of the present application, the first node only performs intra-frequency domain or inter-frequency measurements in one or more reference signal resources comprised in one of the K1 reference signal resource groups at the same time.

According to one aspect of the present application, there at least exists a number of reference signal resources associated with a PCI comprised in a reference signal resource group among the K1 reference signal resource groups being less than a maximum number of SSB(s) comprised in a corresponding PCI in a half-frame.

The present application provides a method in a second node for wireless communications, comprising:
transmitting a first information block, the first information block being used to indicate K1 reference signal resource groups, K1 being a positive integer greater than 1, any of the K1 reference signal resource groups comprising at least one reference signal resource; transmitting a reference signal in at least one reference signal resource in a first reference signal resource group, the first reference signal resource group being one of the K1 reference signal resource groups; and
receiving a first measurement result;
herein, the reference signal resource comprises at least one of an SSB or CSI-RS resources; a transmitter of the first measurement result is a first node; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

According to one aspect of the present application, the first measurement result comprises L1 reference signal index (indices), L1 being a positive integer not greater than a first threshold, and the first threshold is related to the location information of the first node.

According to one aspect of the present application, the first measurement result comprises M1 serving cells, M1 being a positive integer not greater than a second threshold, and the second threshold is related to the location information of the first node.

According to one aspect of the present application, as a response to an occurrence of a first event, the behavior of occurring a first measurement result is triggered; the first event is any candidate event in a first candidate event set; the first measurement result comprises L1 reference signal index (indices), L1 being a positive integer not greater than a first threshold; the first candidate event set is used to determine the first threshold.

According to one aspect of the present application, as a response to an occurrence of a first event, the behavior of occurring a first measurement result is triggered; the first event is any candidate event in a first candidate event set; the first measurement result comprises M1 serving cell(s), M1 being a positive integer not greater than a second threshold; the first candidate event set is used to determine the second threshold.

According to one aspect of the present application, comprising:
the second transceiver, receiving a target information block;
herein, the target information block comprises subscription information of the first node, and K1 is related to the subscription information of the first node.

According to one aspect of the present application, K1 is a positive integer greater than 1, the K1 reference signal resource groups also comprise a second reference signal resource group, and both the first reference signal resource group and the second reference signal resource group comprise a first reference signal resource.

According to one aspect of the present application, as a response to an occurrence of a first event, the behavior of occurring a first measurement result is triggered; the first event is any candidate event in a first candidate event set.

According to one aspect of the present application, any of the K1 reference signal resource groups is associated with multiple PCIs.

According to one aspect of the present application, any of the K1 reference signal resource groups is associated with a first PCI set, and the first PCI set at least comprises two different PCIs.

According to one aspect of the present application, the K1 reference signal resource groups are associated with a same MeasObject.

According to one aspect of the present application, the first node only performs intra-frequency domain or inter-frequency measurements in one or more reference signal resources comprised in one of the K1 reference signal resource groups at the same time.

According to one aspect of the present application, there at least exists a number of reference signal resources associated with a PCI comprised in a reference signal resource group among the K1 reference signal resource groups being less than a maximum number of SSB(s) comprised in a corresponding PCI in a half-frame.

The present application provides a first node for wireless communications, comprising:
a first transceiver, receiving a first information block, the first information block being used to indicate K1 reference signal resource groups, K1 being a positive integer greater than 1, any of the K1 reference signal resource groups comprising at least one reference signal resource; measuring a first reference signal resource group, the first reference signal resource group being one of the K1 reference signal resource groups; and
a first transmitter, transmitting a first measurement result, a measurement for the first reference signal resource group being used to obtain the first measurement result;
herein, the reference signal resource comprises at least one of an SSB or CSI-RS resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

The present application provides a second node for wireless communications, comprising:
a second transceiver, transmitting a first information block, the first information block being used to indicate K1 reference signal resource groups, K1 being a positive integer greater than 1, any of the K1 reference signal resource groups comprising at least one reference signal resource; transmitting a reference signal in at least one reference signal resource in a first reference signal resource group, the first reference signal resource group being one of the K1 reference signal resource groups; and
a first receiver, receiving a first measurement result;
herein, the reference signal resource comprises at least one of an SSB or CSI-RS resources; a transmitter of the first measurement result is a first node; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, compared with traditional solutions, advantages of the present application are: simplifying the measurement complexity of UAV terminals, thereby improving system performance and avoiding resource waste.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a first information block according to one embodiment of the present application;

FIG. 6 illustrates a flowchart of a target information block according to one embodiment of the present application;

FIG. 7 illustrates a schematic diagram of K1 reference signal resource groups according to one embodiment of the present application;

FIG. 8 illustrates a schematic diagram of location information of the first node according to one embodiment of the present application;

FIG. 9 illustrates a schematic diagram of location information of the first node according to another embodiment of the present application;

FIG. 10 illustrates a schematic diagram of an application scenario according to another embodiment of the present application;

FIG. 11 illustrates a structure block diagram of a processor in a first node according to one embodiment of the present application;

FIG. 12 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of the processing of a first node, as shown in FIG. 1. In step 100 illustrated by FIG. 1, each box represents a step. In embodiment 1, a first node in the present application receives a first information block in step 101, the first information block is used to indicate K1 reference signal resource groups, K1 being a positive integer greater than 1, any of the K1 reference signal resource groups comprises at least one reference signal resource; measures a first reference signal resource group in step 102, the first reference signal resource group is one of the K1 reference signal resource groups; transmits a first measurement result in step 103, a measurement for the first reference signal resource group is used to obtain the first measurement result.

In embodiment 1, the reference signal resource comprises at least one of an SSB or CSI-RS resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, any of the K1 reference signal resource groups comprises at least one reference signal.

In one embodiment, the reference signal in the present application comprises an SSB.

In one embodiment, the reference signal in the present application comprises a CSI-RS.

In one embodiment, the reference signal in the present application corresponds to an SSB.

In one embodiment, the reference signal in the present application corresponds to CSI-RS resources.

In one embodiment, the K1 reference signal resource groups are all used for intra-frequency domain or inter-frequency measurements.

In one embodiment, the first information block comprises multiple MeasObjectNR IEs (Information Elements).

In one embodiment, the first information block comprises one or multiple fields in a MeasObjectNR IE.

In one embodiment, the first information block comprises multiple MeasObjectToAddModList IEs.

In one embodiment, the first information block comprises one or multiple fields in a MeasObjectToAddModList IE.

In one embodiment, the first information block comprises multiple MeasConfig.

In one embodiment, the first information block comprises one or multiple fields in a MeasConfig IE.

In one embodiment, the first information block is related to a FlightPathInfoReport IE.

In one embodiment, the first information block is related to a WayPointLocation IE.

In one embodiment, the first information block is related to a LocationInfo IE.

In one embodiment, a name of an RRC (Radio Resource Control) signaling bearing the first information block comprises Meas.

In one embodiment, a name of an RRC signaling bearing the first information block comprises Object.

In one embodiment, a name of an RRC signaling bearing the first information block comprises Config.

In one embodiment, a name of an RRC signaling bearing the first information block comprises Aerial.

In one embodiment, the first information block comprises one or multiple fields in a MeasObjectToAddModList IE.

In one embodiment, the first information block comprises one or multiple fields in a MeasConfig IE.

In one embodiment, the first information block corresponds to a MeasObjectId.

In one embodiment, the first information block corresponds to a MeasId.

In one embodiment, the first information block is transmitted through an RRC signaling.

In one embodiment, the first information block is transmitted through a Medium Access Control (MAC) Control Element (CE).

In one embodiment, K1 is equal to 1.

In one embodiment, K1 is equal to 2.

In one embodiment, K1 is a positive integer greater than 2.

In one embodiment, any of the K1 reference signal resource groups comprises Q1 reference signal resources, Q1 being a positive integer.

In one subembodiment of the above embodiment, any of the Q1 reference signal resources comprises an SSB.

In one subembodiment of the above embodiment, any of the Q1 reference signal resources comprises CSI-RS resources.

In one subembodiment of the above embodiment, any of the Q1 reference signal resources comprises at least one of an SSB or CSI-RS resources.

In one subembodiment of the above embodiment, any of the Q1 reference signal resources comprises one of an SSB or CSI-RS resources.

In one embodiment, a measurement for the first reference signal resource group comprises channel measurement.

In one embodiment, a measurement for the first reference signal resource group comprises an interference measurement.

In one embodiment, a measurement for the first reference signal resource group comprises a channel measurement and an interference measurement.

In one embodiment, the first measurement result is transmitted through an RRC signaling.

In one embodiment, the first measurement result is transmitted through a MAC CE.

In one embodiment, the first measurement result comprises a Measurement Report.

In one embodiment, the first measurement result comprises a MeasurementReport message.

In one embodiment, the measurement for the first reference signal resource group is used to trigger a transmission of the first measurement result.

In one embodiment, location information of the first node corresponds to one of K1 candidate location intervals, and the K1 candidate location intervals respectively correspond to the K1 reference signal resource groups.

In one subembodiment of the embodiment, the location information of the first node corresponds to a first candidate position interval among the K1 candidate position intervals, the first candidate location interval corresponds to a first reference signal resource group among the K1 reference signal resource groups, and the first candidate position interval is used to determine the first reference signal resource group from the K1 reference signal resource groups.

In one embodiment, location information of the first node comprises an altitude of the first node, and the altitude of the first node is used to determine the first reference signal resource group from the K1 reference signal resource groups.

In one subembodiment of the embodiment, the altitude of the first node belongs to one of K1 altitude intervals, and the K1 altitude intervals respectively correspond to the K1 reference signal resource groups.

In one subsidiary embodiment of the subembodiment, the altitude of the first node belongs to a first altitude interval among the K1 altitude intervals, the first altitude interval corresponds to a first reference signal resource group among the K1 reference signal resource groups, and the first altitude interval is used to determine the first reference signal resource group from the K1 reference signal resource groups.

In one embodiment, location information of the first node comprises a WayPointLocation of the first node, and the WayPointLocation of the first node is used to determine the first reference signal resource group from the K1 reference signal resource groups.

In one subembodiment of the embodiment, the WayPointLocation of the first node is one of the K1 WayPointLocations, and the K1 WayPointLocations respectively correspond to the K1 reference signal resource groups.

In one subsidiary embodiment of the subembodiment, the WayPointLocation of the first node is a first WayPointLocation among the K1 WayPointLocations, the first WayPointLocation corresponds to a first reference signal resource group among the K1 reference signal resource groups, and the first WayPointLocation is used to determine the first reference signal resource group from the K1 reference signal resource groups.

In one embodiment, location information of the first node comprises the altitude of the first node and the WayPointLocation of the first node, the altitude of the first node and the WayPointLocation of the first node are used together to determine the first reference signal resource group from the K1 reference signal resource groups.

In one subembodiment of the embodiment, the altitude of the first node belongs to one of K2 altitude intervals, and the WayPointLocation of the first node is one of K3 WayPointLocations, a product of K2 and K3 is equal to K1, and K1 combinations formed by the K2 altitude intervals and the K3 WayPointLocations correspond one-to-one to the K1 reference signal resource groups.

In one subsidiary embodiment of the subembodiment, the altitude of the first node and the WayPointLocation of the first node are used together to determine a first combination from the K1 combinations, the first combination corresponds to a first reference signal resource group among the K1 reference signal resource groups, and the first combination is used to determine the first reference signal resource group from the K1 reference signal resource groups.

### Embodiment 2

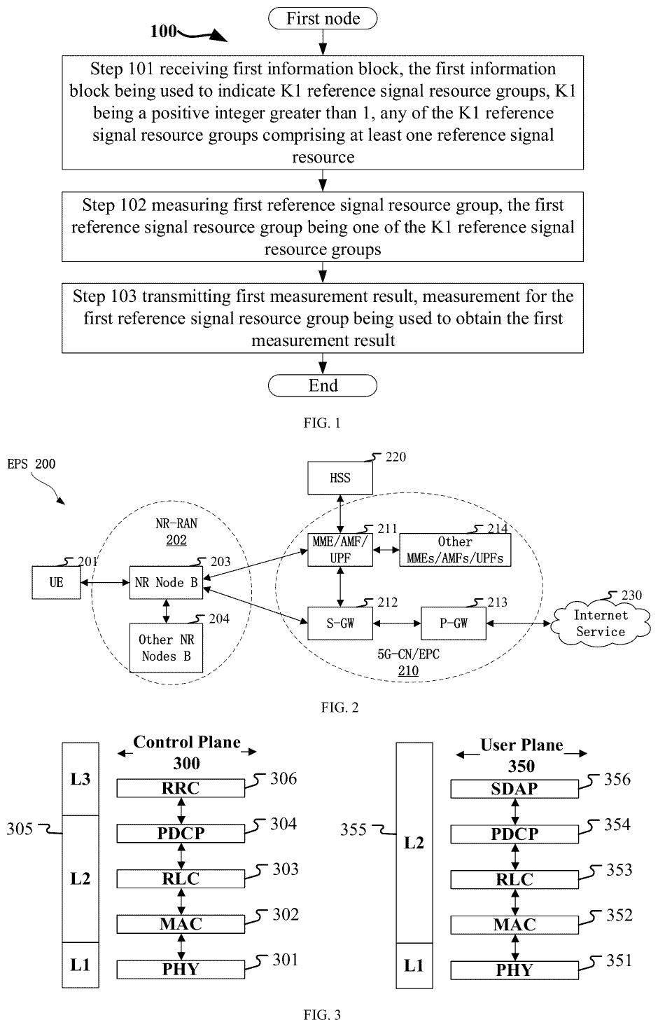

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multi-media devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multi-media Subsystem (IMS) and Packet Switching Streaming Services (PSS).

In one embodiment, the UE 201 corresponds to the first node in the present application.

In one embodiment, the UE 201 comprises a UAV terminal.

In one embodiment, the UE 201 is a terminal capable of monitoring multiple beams at the same time.

In one embodiment, the UE 201 is a terminal supporting Massive-MIMO.

In one embodiment, the UE 201 has a flight capability.

In one embodiment, the UE 201 comprises an AV (Aerial Vehicles) terminal.

In one embodiment, the gNB 203 corresponds to the second node in the present application.

In one embodiment, the gNB 203 supports providing services for UAV terminals.

In one embodiment, the gNB 203 supports a transmission of multi-beam.

In one embodiment, the gNB 203 supports a transmission based on Massive-MIMO.

In one embodiment, the gNB 203 supports providing services for AV terminals.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first information block in the present application is generated by the MAC 302 or the MAC 352.

In one embodiment, the first information block in the present application is generated by the RRC 306.

In one embodiment, the first measurement result in the present application is generated by the MAC 302 or the MAC 352.

In one embodiment, the first measurement result in the present application is generated by the RRC 306.

In one embodiment, the target information block in the present application is generated by the MAC 302 or the MAC 352.

In one embodiment, the target information block in the present application is generated by the RRC 306.

In one embodiment, the first node is a terminal.

In one embodiment, the first node is a UAV.

In one embodiment, the first node is an AV.

In one embodiment, the second node is a terminal.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used to manage multiple TRPs.

In one embodiment, the second node is a node used for managing multiple cells.

In one embodiment, the first node is capable of accessing multiple cells at the same time.

### Embodiment 4

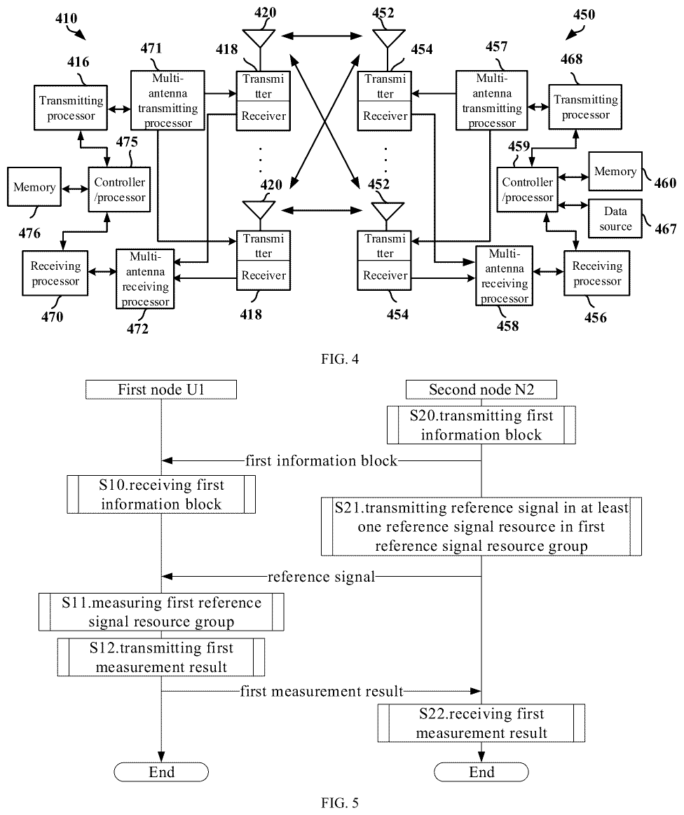

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first information block, the first information block is used to indicate K1 reference signal resource groups, K1 being a positive integer greater than 1, any of the K1 reference signal resource groups comprises at least one reference signal resource; then measures a first reference signal resource group, the first reference signal resource group being one of the K1 reference signal resource groups; transmits a first measurement result, a measurement for the first reference signal resource group is used to obtain the first measurement result; the reference signal resource comprises at least one of an SSB or CSI-RS resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, the first communication device 450 comprises at least one processor and at least one memory. a memory that stores a computer readable instruction program. The computer readable instruction program generates an action when executed by at least one processor. The action includes: first receiving a first information block, the first information block being used to indicate K1 reference signal resource groups, K1 being a positive integer greater than 1, any of the K1 reference signal resource groups comprising at least one reference signal resource; then measuring a first reference signal resource group, the first reference signal resource group being one of the K1 reference signal resource groups; and transmitting a first measurement result, a measurement for the first reference signal resource group being used to obtain the first measurement result; the reference signal resource comprises at least one of an SSB or CSI-RS resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first information block, the first information block is used to indicate K1 reference signal resource groups, K1 being a positive integer greater than 1, any of the K1 reference signal resource groups comprises at least one reference signal resource; then transmits a reference signal in at least one reference signal resource in a first reference signal resource group, the first reference signal resource group being one of the K1 reference signal resource groups; and receives a first measurement result; the reference signal resource comprises at least one of an SSB or CSI-RS resources; a transmitter of the first measurement result is a first node; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, the second communication device 410 comprises a memory that stores a computer readable instruction program. The computer readable instruction program generates an action when executed by at least one processor. The action includes: first transmitting a first information block, the first information block being used to indicate K1 reference signal resource groups, K1 being a positive integer greater than 1, any of the K1 reference signal resource groups comprising at least one reference signal resource; then transmitting a reference signal in at least one reference signal resource in a first reference signal resource group, the first reference signal resource group being one of the K1 reference signal resource groups; and receiving a first measurement result; the reference signal resource comprises at least one of an SSB or CSI-RS resources; a transmitter of the first measurement result is a first node; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the first communication device 450 is a UAV.

In one embodiment, the first communication device 450 is an AV.

In one embodiment, the second communication device 410 is a base station.

In one embodiment, the second communication device 410 is a UE.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first information block; at least first four of the antenna 420, the transmitter 418, the multi-antenna transmitting processor 471, the transmitting processor 416 and the controller/processor 475 are used to transmit a first information block.

In one embodiment, at least first four of the antenna 452, the receiver 454, the multi-antenna receiving processor 458, the receiving processor 456 and the controller/processor 459 are used to measure a first reference signal resource group, and the first reference signal resource group being one of the K1 reference signal resource groups; at least first four of the antenna 420, the transmitter 418, the multi-antenna transmitting processor 471, the transmitting processor 416 and the controller/processor 475 are used to transmit a reference signal in at least one reference signal resource in a first reference signal resource group.

In one embodiment, at least first four of the antenna 452, the transmitter 454, the multi-antenna transmitting processor 457, the transmitting processor 468, and the controller/processor 459 are used to transmit a first measurement result; at least first four of the antenna 420, the receiver 418, the multi-antenna receiving processor 472, the receiving processor 470 and the controller/processor 475 are used to receive a first measurement result.

In one embodiment, at least first four of the antenna 452, the transmitter 454, the multi-antenna transmitting processor 457, the transmitting processor 468, and the controller/processor 459 are used to transmit a target information block; at least first four of the antenna 420, the receiver 418, the multi-antenna receiving processor 472, the receiving processor 470 and the controller/processor 475 are used to receive a target information block.

### Embodiment 5

Embodiment 5 illustrates a flowchart of a first information block, as shown in FIG. 5. In FIG. 5, a first node U1 and a second node N2 are in communications via a radio link. It is particularly underlined that the order illustrated in the embodiment does not put constraints over sequences of signal transmissions and implementations. In the absence of conflict, embodiments, sub-embodiments, and subsidiary embodiments of Embodiment 5 can be used in embodiment 6; similarly, any of the embodiments, sub-embodiments, and subsidiary embodiments of Embodiment 6 can be used in embodiment 5 without conflict.

The first node U1 receives a first information block in step S10; measures a first reference signal resource group in step S11; transmits a first measurement result in step S12.

The second node N2 transmits a first information block in step S20; transmits a reference signal in at least one reference signal resource in a first reference signal resource group in step S21; receives a first measurement result in step S22.

In embodiment 5, the first information block is used to indicate K1 reference signal resource groups, K1 being a positive integer greater than 1, any of the K1 reference signal resource groups comprises at least one reference signal resource; the first reference signal resource group is one of the K1 reference signal resource groups; a measurement for the first reference signal resource group is used to obtain the first measurement result; the reference signal resource comprises at least one of an SSB or CSI-RS resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, the first reference signal resource group comprises a reference signal transmitted by a node other than the second node.

Typically, the first measurement result comprises L1 reference signal index (indices), L1 being a positive integer not greater than a first threshold, and the first threshold is related to the location information of the first node.

In one embodiment, the location information of the first node comprises an altitude of the first node; the altitude of the first node becomes greater than an absolute threshold, and the first threshold is equal to a first integer.

In one embodiment, the location information of the first node comprises an altitude of the first node; the altitude of the first node becomes not greater than an absolute threshold, and the first threshold is equal to a second integer.

In one embodiment, the location information of the first node comprises an altitude of the first node; the altitude of the first node becomes less than an absolute threshold, and the first threshold is equal to a third integer.

In one embodiment, the location information of the first node comprises an altitude of the first node; the altitude of the first node becomes not less than an absolute threshold, and the first threshold is equal to a fourth integer.

In one embodiment, the location information of the first node comprises an altitude of the first node; the altitude of the first node belongs to one of the K1 altitude intervals, and the K1 altitude intervals respectively correspond to K1 first-type integer values.

In one subembodiment of the embodiment, the altitude of the first node belongs to a given altitude interval among the K1 altitude intervals, the given altitude interval is any altitude interval among the K1 altitude intervals, the given altitude interval corresponds to a given first-type integer value among the K1 first-type integer values, and the first threshold is equal to the given first-type integer value.

In one embodiment, the location information of the first node comprises a WayPointLocation of the first node; the WayPointLocation of the first node is one of K1 WayPointLocations, and the K1 WayPointLocations respectively correspond to K1 first-type integer values.

In one subembodiment of the embodiment, the WayPointLocation of the first node is a given WayPointLocation among the K1 WayPointLocations, the given path point is any WayPointLocation among the K1 WayPointLocations, the given WayPointLocation corresponds to a given first-type integer value among the K1 first-type integer values, and the first threshold is equal to the given first-type integer value.

In one embodiment, the L1 reference signal index (indices) at least comprises a reference signal index being an SS/PBCH block index.

In one embodiment, the L1 reference signal index (indices) at least comprises a reference signal index being a CSI-RS index.

In one embodiment, any of the L1 reference signal index (indices) is an SS/PBCH block index or a CSI-RS index.

In one embodiment, the L1 reference signal index (indices) corresponds (respectively correspond) to L1 reference signal resources.

Typically, the first measurement result comprises M1 serving cells, M1 being a positive integer not greater than a second threshold, and the second threshold is related to the location information of the first node.

In one embodiment, the location information of the first node comprises an altitude of the first node; the altitude of the first node becomes greater than an absolute threshold, and the second threshold is equal to a fifth integer.

In one embodiment, the location information of the first node comprises an altitude of the first node; the altitude of the first node becomes not greater than an absolute threshold, and the second threshold is equal to a sixth integer.

In one embodiment, the location information of the first node comprises an altitude of the first node; the altitude of the first node becomes less than an absolute threshold, and the second threshold is equal to a seventh integer.

In one embodiment, the location information of the first node comprises an altitude of the first node; the altitude of the first node becomes not less than an absolute threshold, and the second threshold is equal to an eighth integer.

In one embodiment, the location information of the first node comprises an altitude of the first node; the altitude of the first node belongs to one of the K1 altitude intervals, and the K1 altitude intervals respectively correspond to K1 first-type integer values.

In one subembodiment of the embodiment, the altitude of the first node belongs to a given altitude interval among the K1 altitude intervals, the given altitude interval is any altitude interval among the K1 altitude intervals, the given altitude interval corresponds to a given second-type integer value among the K1 second-type integer values, and the second threshold is equal to the given second-type integer value.

In one embodiment, the location information of the first node comprises a WayPointLocation of the first node; the WayPointLocation of the first node is one of K1 WayPointLocations, and the K1 WayPointLocations respectively correspond to K1 second-type integer values.

In one subembodiment of the embodiment, the WayPointLocation of the first node is a given WayPointLocation among the K1 WayPointLocations, the given WayPointLocation is any WayPointLocation among the K1 WayPointLocations, the given WayPointLocation corresponds to a given second-type integer value among the K1 second-type integer values, and the second threshold is equal to a given second-type integer value.

In one embodiment, the M1 serving cells respectively correspond to M1 PCIs (Physical Cell Identities).

In one embodiment, the M1 serving cells correspond to M1 serving cells respectively.

In one embodiment, the M1 serving cells correspond to M1 non-serving cells respectively.

In one embodiment, the M1 serving cells correspond to M1 deactivated serving cells respectively.

In one embodiment, the M1 serving cells correspond to M1 candidate serving cells respectively.

Typically, as a response to an occurrence of a first event, the behavior of occurring a first measurement result is triggered; the first event is any candidate event in a first candidate event set; the first measurement result comprises L1 reference signal index (indices), L1 being a positive integer not greater than a first threshold; the first candidate event set is used to determine the first threshold.

In one embodiment, the first candidate event set comprises that an altitude of the first node exceed a first threshold.

In one embodiment, the first candidate event set comprises that an altitude of the first node is less than a first threshold.

In one embodiment, the first candidate event set comprises re-determining the first reference signal resource group.

In one embodiment, the first candidate event set only comprises the first event.

In one embodiment, the first candidate event set comprises multiple candidate events.

In one embodiment, the meaning of the above phrase that the first candidate event set is used to determine the first threshold comprises: when any candidate event in the first candidate event set is used to trigger a transmission of the first measurement result, the first threshold is equal to W1, W1 being a positive integer; when an event outside the first candidate event set is used to trigger a transmission of the first measurement result, the first threshold is equal to W2, W2 being a positive integer; W1 is different from W2.

In one subembodiment of the above embodiment, W1 is less than W2.

Typically, as a response to an occurrence of a first event, the behavior of occurring a first measurement result is triggered; the first event is any candidate event in a first candidate event set; the first measurement result comprises M1 serving cell(s), M1 being a positive integer not greater than a second threshold; the first candidate event set is used to determine the second threshold.

In one embodiment, the first candidate event set comprises that a WayPointLocation of the first node is equal to a first WayPointLocation.

In one embodiment, the first candidate event set comprises re-determining the first reference signal resource group.

In one embodiment, the first candidate event set only comprises the first event.

In one embodiment, the first candidate event set comprises multiple candidate events.

In one embodiment, the meaning of the above phrase that the first candidate event set is used to determine the second threshold comprises: when any candidate event in the first candidate event set is used to trigger a transmission of the first measurement result, the second threshold is equal to W3, W3 being a positive integer; when an event outside the first candidate event set is used to trigger a transmission of the first measurement result, the second threshold is equal to W4, W4 being a positive integer; W3 is different from W4.

In one subembodiment of the above embodiment, W3 is less than W4.

Typically, K1 is a positive integer greater than 1, the K1 reference signal resource groups also comprise a second reference signal resource group, and both the first reference signal resource group and the second reference signal resource group comprise a first reference signal resource.

In one embodiment, the first reference signal resource comprises at least one of an SSB or CSI-RS resources.

In one embodiment, the second reference signal resource group comprises a second reference signal resource, and the second reference signal resource does not belong to the first reference signal resource group.

In one embodiment, the first reference signal resource group and the second reference signal resource group correspond to two different MeasObjectNR, respectively.

In one embodiment, the first reference signal resource group and the second reference signal resource group correspond to two different MeasobjectIds, respectively.

In one embodiment, the first reference signal resource group and the second reference signal resource group correspond to two different Measobjects, respectively.

In one embodiment, the first reference signal resource group and the second reference signal resource group correspond to two different MeasConfig, respectively.

In one embodiment, the first reference signal resource group and the second reference signal resource group correspond to two different referenceSignalConfig, respectively.

In one embodiment, the second reference signal resource group comprises multiple reference signal resources, and any of the multiple reference signal resources comprises one of an SSB or CSI-RS resources.

Typically, any of the K1 reference signal resource groups is associated with a same PCI.

In one embodiment, the K1 reference signal resource groups correspond to K1 different MeasObjectNR, respectively.

In one embodiment, the K1 reference signal resource groups correspond to K1 different MeasobjectIds, respectively.

In one embodiment, the K1 reference signal resource groups correspond to K1 different Measobjects, respectively.

In one embodiment, the K1 reference signal resource groups correspond to K1 different MeasConfig, respectively.

In one embodiment, the K1 reference signal resource groups correspond to K1 different referenceSignalConfig, respectively.

Typically, any of the K1 reference signal resource groups is associated with multiple PCIs.

Typically, any of the K1 reference signal resource groups is associated with a first PCI set, and the first PCI set at least comprises two different PCIs.

Typically, the K1 reference signal resource groups are associated with a same MeasObject.

Typically, the first node only performs intra-frequency domain or inter-frequency measurements in one or more reference signal resources comprised in one of the K1 reference signal resource groups at the same time.

Typically, there at least exists a number of reference signal resources associated with a PCI comprised in a reference signal resource group among the K1 reference signal resource groups being less than a maximum number of SSB(s) comprised in a corresponding PCI in a half-frame.

### Embodiment 6

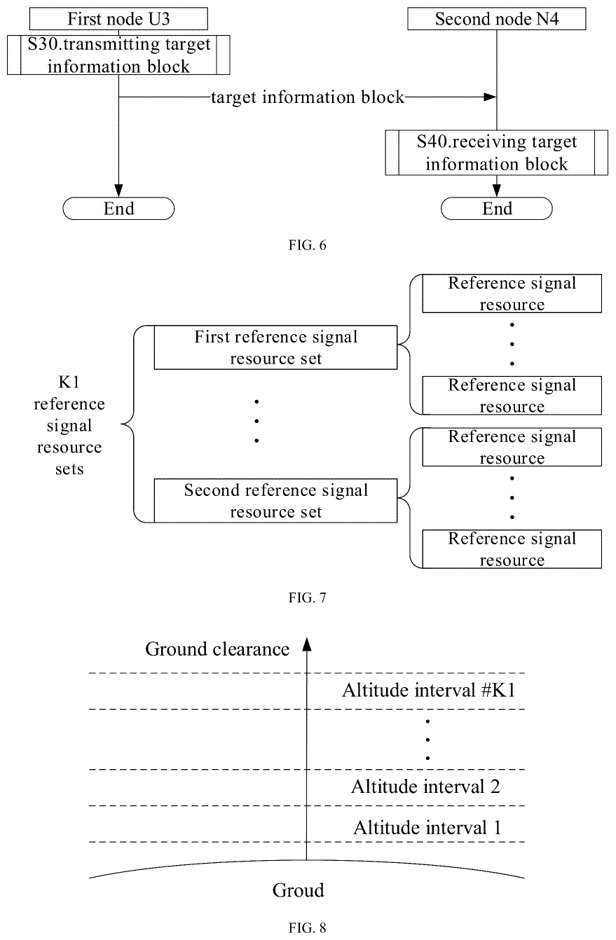

Embodiment 6 illustrates a flowchart of a target information block, as shown in FIG. 6. In FIG. 6, a first node U3 and a second node N4 are in communications via a radio link. It is particularly underlined that the order illustrated in the embodiment does not put constraints over sequences of signal transmissions and implementations. In the absence of conflict, embodiments, sub-embodiments, and subsidiary embodiments of Embodiments 6 can be used in embodiment 5; similarly, any of the embodiments, sub-embodiments, and subsidiary embodiments of Embodiments 5 can be used in embodiment 6 without conflict.

The first node U3 transmits a target information block in step 530.

The second node N4 receives a target information block in step 540.

In embodiment 6, the target information block comprises subscription information of the first node, and K1 is related to the subscription information of the first node.

In one embodiment, the subscription information of the first node is used to determine that the first node is an Aerial UE.

In one embodiment, the subscription information of the first node is used to determine whether the first node is an Aerial UE.

In one embodiment, the subscription information of the first node comprises Subscription handling for Aerial UE.

In one embodiment, the subscription information of the first node is used to support operating of Aerial UE Function.

In one embodiment, the subscription information of the first node is stored in registration information of HSS of the first node.

In one embodiment, the subscription information of the first node comprises aerial-UE identification.

In one embodiment, the subscription information of the first node is used to determine that the first node is an Aerial UE, K1 being greater than 1.

In one embodiment, the subscription information of the first node is used to determine that the first node is not an Aerial UE, K1 being equal to 1.

In one embodiment, the subscription information of the first node is used to determine a value of K1.

In one embodiment, a transmitting base station of the first information block receives subscription information of the first node from an MME (Mobility Management Entity), and determines that K1 is greater than 1 according to subscription information of the first node.

In one embodiment, a transmitting base station of the first information block receives subscription information of the first node through an Xn interface, and determines that K1 is greater than 1 according to subscription information of the first node.

In one embodiment, the subscription information of the first node comprises an Aerial UE Authorization.

In one embodiment, the subscription information of the first node indicates that the first node is an airborne UE, and for the airborne UE, the K1 candidate values comprise a positive integer greater than 1; for a legacy UE, K1 is fixed at 1.

In one embodiment, the legacy UE refers to a UE that supports 3GPP Release 17 or earlier releases.

In one embodiment, the target information block is transmitted through an RRC signaling.

In one embodiment, the target information block is transmitted through a MAC CE.

In one embodiment, the target information block comprises one or multiple fields in a UEInformationResponse message.

In one embodiment, a name of an RRC signaling bearing the target information block comprises UE.

In one embodiment, a name of an RRC signaling bearing the target information block comprises Information.

In one embodiment, a name of an RRC signaling bearing the target information block comprises Response.

In one embodiment, a name of an RRC signaling bearing the target information block comprises Aerial.

In one embodiment, the step S30 is taken before step S10 in Embodiment 5.

In one embodiment, the step S40 is taken after step S20 in Embodiment 5.

### Embodiment 7

Embodiment 7 illustrates a schematic diagram of K1 reference signal resource groups, as shown in FIG. 7. In FIG. 7, the K1 reference signal resource groups comprise a first reference signal resource group and a second reference signal resource group, the first reference signal resource group comprises Q1 reference signal resources, and the second reference signal resource group comprises Q2 reference signal resources; Q1 and Q2 are both positive integers greater than 1.

In one embodiment, the Q1 reference signal resources comprise the first reference signal resource in the present application.

In one embodiment, the Q2 reference signal resources comprise the first reference signal resource in the present application.

In one embodiment, the Q1 reference signal resources at least comprise two reference signal resources being respectively associated with two different PCIs.

In one embodiment, the Q1 reference signal resources at least comprise two reference signal resources being respectively associated with a same PCI.

In one embodiment, the Q2 reference signal resources at least comprise two reference signal resources being respectively associated with two different PCIs.

In one embodiment, the Q2 reference signal resources at least comprise two reference signal resources being respectively associated with a same PCI.

In one embodiment, when an altitude of the first node exceeds an absolute threshold, a measurement for the first reference signal resource group is used to trigger reporting of the first measurement result; when an altitude of the first node does not exceed an absolute threshold, a measurement for the second reference signal resource group is used to trigger reporting of the first measurement result.

### Embodiment 8

Embodiment 8 illustrates a schematic diagram of location information of a first node, as shown in FIG. 8. In FIG. 8, location information of the first node belongs to one of the K1 altitude intervals, the K1 altitude intervals corresponding to altitude interval #1 to altitude interval #K1 in the figure; the K1 altitude intervals correspond to the K1 reference signal resource sets, respectively.

In one embodiment, a given altitude interval is any of the K1 altitude intervals, and when the first node is located in the given altitude interval, the first reference signal resource set is a reference signal resource set corresponding to the given altitude interval among the K1 reference signal resource sets.

In one embodiment, the first node determines by itself an altitude at which it is located.

In one embodiment, the first node determines an altitude at which the first node is located by receiving a signal from a base station.

In one embodiment, the first node determines an altitude at which the first node is located by means of GNSS (Global Navigation Satellite System).

### Embodiment 9

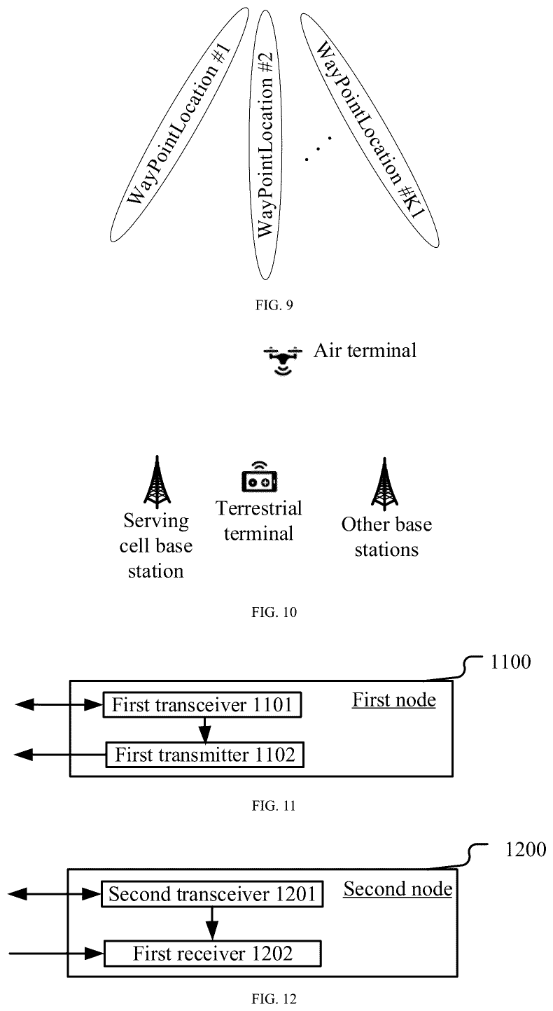

Embodiment 9 illustrates another schematic diagram of location information of a first node, as shown in FIG. 9. In FIG. 9, location information of the first node comprises a WayPointLocation of the first node, the WayPointLocation of the first node is one of K1 WayPointLocations, the K1 WayPointLocations respectively correspond to WayPointLocation #1 to WayPointLocation #K1 in the figure; the K1 WayPointLocations correspond to the K1 reference signal resource sets, respectively.

In one embodiment, the K1 WayPointLocations respectively correspond to K1 ways adopted when the first node moves.

In one embodiment, the first node moves by adopting one of the K1 WayPointLocations.

In one embodiment, the K1 WayPointLocations respectively correspond to coverage areas of K1 serving cells.

In one embodiment, the K1 WayPointLocations are respectively associated with K1 tracking areas.

In one embodiment, the first node determines the WayPointLocation of the first node by receiving a signal from the base station.

In one embodiment, the first node determines the WayPointLocation of the first node through GNSS.

### Embodiment 10

Embodiment 10 illustrates a schematic diagram of an application scenario, as shown in FIG. 10. In FIG. 10, the air terminal corresponds to the first node in the present application, a serving cell corresponds to a second node in the present application, and other cells correspond to adjacent cells of the serving cell; the terrestrial terminal in the figure is a terminal served by the serving cell; the first node performs measurements for the serving cell and other cells.

In one embodiment, the first reference signal resource set comprises reference signal resources associated with the serving cell and the other cells.

In one embodiment, the second reference signal resource set comprises reference signal resources associated with the serving cell and the other cells.

### Embodiment 11

Embodiment 11 illustrates a structure block diagram of a first node, as shown in FIG. 11. In FIG. 11, the first node 1100 comprises a first transceiver 1101 and a first transmitter 1102.

A first transceiver 1101 receives a first information block, the first information block is used to indicate K1 reference signal resource groups, K1 being a positive integer greater than 1, any of the K1 reference signal resource groups comprises at least one reference signal resource; measures a first reference signal resource group, the first reference signal resource group being one of the K1 reference signal resource groups;
a first transmitter 1102 transmits a first measurement result, and a measurement for the first reference signal resource group is used to obtain the first measurement result;

In embodiment 11, the reference signal resource comprises at least one of an SSB or CSI-RS resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, the first measurement result comprises L1 reference signal index (indices), L1 being a positive integer not greater than a first threshold, and the first threshold is related to the location information of the first node.

In one embodiment, the first measurement result comprises M1 serving cells, M1 being a positive integer not greater than a second threshold, and the second threshold is related to the location information of the first node.

In one embodiment, as a response to an occurrence of a first event, the behavior of occurring a first measurement result is triggered; the first event is any candidate event in a first candidate event set; the first measurement result comprises L1 reference signal index (indices), L1 being a positive integer not greater than a first threshold; the first candidate event set is used to determine the first threshold.

In one embodiment, as a response to an occurrence of a first event, the behavior of occurring a first measurement result is triggered; the first event is any candidate event in a first candidate event set; the first measurement result comprises M1 serving cell(s), M1 being a positive integer not greater than a second threshold; the first candidate event set is used to determine the second threshold.

In one embodiment, comprising:
the first transceiver 1101 transmitting a target information block,
herein, the target information block comprises subscription information of the first node, and K1 is related to the subscription information of the first node.

In one embodiment, K1 is a positive integer greater than 1, the K1 reference signal resource groups also comprise a second reference signal resource group, and both the first reference signal resource group and the second reference signal resource group comprise a first reference signal resource.

In one embodiment, as a response to an occurrence of a first event, the behavior of occurring a first measurement result is triggered; the first event is any candidate event in a first candidate event set.

In one embodiment, any of the K1 reference signal resource groups is associated with multiple PCIs.

In one embodiment, any of the K1 reference signal resource groups is associated with a first PCI set, and the first PCI set at least comprises two different PCIs.

In one embodiment, the K1 reference signal resource groups are associated with a same MeasObject.

In one embodiment, the first node only performs intra-frequency domain or inter-frequency measurements in one or more reference signal resources comprised in one of the K1 reference signal resource groups at the same time.

In one embodiment, there at least exists a number of reference signal resources associated with a PCI comprised in a reference signal resource group among the K1 reference signal resource groups being less than a maximum number of SSB(s) comprised in a corresponding PCI in a half-frame.

In one embodiment, the first transceiver 1101 comprises at least first six of the antenna 452, the receiver/transmitter 454, the multi-antenna receiving processor 458, the multi-antenna transmitting processor 457, the receiving processor 456, the transmitting processor 468, and the controller/processor 459 in embodiment 4.

In one embodiment, the first transmitter 1102 comprises at least the first four of the antenna 452, the transmitter 454, the multi-antenna transmitting processor 457, the transmitting processor 468 and the controller/processor 459 in embodiment 4.

### Embodiment 12

Embodiment 12 illustrates a structure block diagram of in a second node, as shown in FIG. 12. In FIG. 12, the second node 1200 comprises a second transceiver 1201 and a first receiver 1202.

A second transceiver 1201 transmits a first information block, the first information block is used to indicate K1 reference signal resource groups, K1 being a positive integer greater than 1, any of the K1 reference signal resource groups comprises at least one reference signal resource; transmits a reference signal in at least one reference signal resource in a first reference signal resource group, the first reference signal resource group being one of the K1 reference signal resource groups;
a first receiver 1202 receives a first measurement result;

In embodiment 12, the reference signal resource comprises at least one of an SSB or CSI-RS resources; a transmitter of the first measurement result is a first node; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

In one embodiment, the first measurement result comprises L1 reference signal index (indices), L1 being a positive integer not greater than a first threshold, and the first threshold is related to the location information of the first node.

In one embodiment, the first measurement result comprises M1 serving cells, M1 being a positive integer not greater than a second threshold, and the second threshold is related to the location information of the first node.

In one embodiment, as a response to an occurrence of a first event, the behavior of occurring a first measurement result is triggered; the first event is any candidate event in a first candidate event set; the first measurement result comprises L1 reference signal index (indices), L1 being a positive integer not greater than a first threshold; the first candidate event set is used to determine the first threshold.

In one embodiment, as a response to an occurrence of a first event, the behavior of occurring a first measurement result is triggered; the first event is any candidate event in a first candidate event set; the first measurement result comprises M1 serving cell(s), M1 being a positive integer not greater than a second threshold; the first candidate event set is used to determine the second threshold.

In one embodiment, comprising:
the second transceiver 1201 receiving a target information block;
herein, the target information block comprises subscription information of the first node, and K1 is related to the subscription information of the first node.

In one embodiment, K1 is a positive integer greater than 1, the K1 reference signal resource groups also comprise a second reference signal resource group, and both the first reference signal resource group and the second reference signal resource group comprise a first reference signal resource.

In one embodiment, as a response to an occurrence of a first event, the behavior of occurring a first measurement result is triggered; the first event is any candidate event in a first candidate event set.

In one embodiment, any of the K1 reference signal resource groups is associated with multiple PCIs.

In one embodiment, any of the K1 reference signal resource groups is associated with a first PCI set, and the first PCI set at least comprises two different PCIs.

In one embodiment, the K1 reference signal resource groups are associated with a same MeasObject.

In one embodiment, the first node only performs intra-frequency domain or inter-frequency measurements in one or more reference signal resources comprised in one of the K1 reference signal resource groups at the same time.

In one embodiment, there at least exists a number of reference signal resources associated with a PCI comprised in a reference signal resource group among the K1 reference signal resource groups being less than a maximum number of SSB(s) comprised in a corresponding PCI in a half-frame.

In one embodiment, the second transceiver 1201 comprises at least first six of the antenna 420, the transmitter/receiver 418, the multi-antenna transmitting processor 471, the multi-antenna receiving processor 472, the transmitting processor 416, the receiving processor 470, and the controller/processor 475 in embodiment 4.

In one embodiment, the first receiver 1202 comprises at least the first six of the antenna 420, the receiver 418, the multi-antenna receiving processor 472, the receiving processor 470 and the controller/processor 475 in embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, telecontrolled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first transceiver, receiving a first information block, the first information block being used to indicate K1 reference signal resource groups, K1 being a positive integer greater than 1, any of the K1 reference signal resource groups comprising at least one reference signal resource; measuring a first reference signal resource group, the first reference signal resource group being one of the K1 reference signal resource groups; and
a first transmitter, transmitting a first measurement result, a measurement for the first reference signal resource group being used to obtain the first measurement result;
wherein the reference signal resource comprises at least one of an SSB (Synchronization Signal/physical broadcast channel Block) or CSI-RS (Channel State Information Reference Signal) resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

2. The first node according to claim 1, wherein the first measurement result comprises L1 reference signal index (indices), L1 being a positive integer not greater than a first threshold, and the first threshold is related to the location information of the first node.

3. The first node according to claim 1, wherein the first measurement result comprises M1 serving cells, M1 being a positive integer not greater than a second threshold, and the second threshold is related to the location information of the first node.

4. The first node according to claim 2, wherein as a response to an occurrence of a first event, the behavior of occurring a first measurement result is triggered; the first event is any candidate event in a first candidate event set; the first measurement result comprises L1 reference signal index (indices), L1 being a positive integer not greater than a first threshold; the first candidate event set is used to determine the first threshold.

5. The first node according to claim 3, wherein as a response to an occurrence of a first event, the behavior of occurring a first measurement result is triggered; the first event is any candidate event in a first candidate event set; the first measurement result comprises M1 serving cell(s), M1 being a positive integer not greater than a second threshold; the first candidate event set is used to determine the second threshold.

6. The first node according to claim 1, comprising:
the first transceiver, transmitting a target information block;
wherein the target information block comprises subscription information of the first node, and K1 is related to the subscription information of the first node.

7. The first node according to claim 1, wherein K1 is a positive integer greater than 1, the K1 reference signal resource groups also comprise a second reference signal resource group, and both the first reference signal resource group and the second reference signal resource group comprise a first reference signal resource.

8. The first node according to claim 1, wherein location information of the first node comprises the altitude of the first node.

9. The first node according to claim 1, wherein the reference signal corresponds to an SSB.

10. The first node according to claim 1, wherein the first information block comprises one or multiple fields in a MeasObjectNR IE.

11. The first node according to claim 1, wherein any of the K1 reference signal resource groups comprises Q1 reference signal resources, Q1 being a positive integer, and any of the Q1 reference signal resources comprises an SSB.

12. The first node according to claim 1, wherein location information of the first node comprises an altitude of the first node, and the altitude of the first node is used to determine the first reference signal resource group from the K1 reference signal resource groups.

13. The first node according to claim 12, wherein the altitude of the first node belongs to one of K1 altitude intervals, and the K1 altitude intervals respectively correspond to the K1 reference signal resource groups.

14. The first node according to claim 1, wherein a name of an RRC signaling bearing the target information block comprises Aerial.

15. The first node according to claim 1, wherein the subscription information of the first node is used to determine that the first node is an Aerial UE, K1 being greater than 1.

16. The first node according to claim 1, wherein any of the K1 reference signal resource groups is associated with a same PCI.

17. The first node according to claim 1, wherein any of the K1 reference signal resource groups is associated with a first PCI set, and the first PCI set at least comprises two different PCIs.

18. The first node according to claim 1, wherein there at least exists a number of reference signal resources associated with a PCI comprised in a reference signal resource group among the K1 reference signal resource groups being less than a maximum number of SSB(s) comprised in a corresponding PCI in a half-frame.

19. A second node for wireless communications, comprising:
a second transceiver, transmitting a first information block, the first information block being used to indicate K1 reference signal resource groups, K1 being a positive integer greater than 1, any of the K1 reference signal resource groups comprising at least one reference signal resource; transmitting a reference signal in at least one reference signal resource in a first reference signal resource group, the first reference signal resource group being one of the K1 reference signal resource groups; and
a first receiver, receiving a first measurement result;
wherein the reference signal resource comprises at least one of an SSB or CSI-RS resources; a transmitter of the first measurement result is a first node, and location information of the first node is used to determine a first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.

20. A method in a first node for wireless communications, comprising:
receiving a first information block, the first information block being used to indicate K1 reference signal resource groups, K1 being a positive integer greater than 1, any of the K1 reference signal resource groups comprising at least one reference signal resource; measuring a first reference signal resource group, the first reference signal resource group being one of the K1 reference signal resource groups; and
transmitting a first measurement result, a measurement for the first reference signal resource group being used to obtain the first measurement result;
wherein the reference signal resource comprises at least one of an SSB or CSI-RS resources; location information of the first node is used to determine the first reference signal resource group from the K1 reference signal resource groups; location information of the first node comprises an altitude of the first node, or location information of the first node comprises a WayPointLocation of the first node, or location information of the first node comprises an altitude of the first node and a WayPointLocation of the first node.
